(19) United States
(12) Patent Application Publication
(10) Pub. No.: US 2023/0222533 A1
(43) Pub. Date: Jul. 13, 2023

(54) SYSTEM AND METHOD OF SPONSORING STREAMING FUNDING

(71) Applicant: TOOTHLIFE CO., LTD., Gyeonggi-do (KR)

(72) Inventors: Yun Sung CHOO, Gyeonggi-do (KR); Won Pyo HONG, Gyeonggi-do (KR); Joo Won KIM, Gyeonggi-do (KR)

(21) Appl. No.: 17/940,754

(22) Filed: Sep. 8, 2022

(30) Foreign Application Priority Data
Jan. 12, 2022 (KR) 10-2022-0004651
Feb. 25, 2022 (KR) 10-2022-0025035

(51) Int. Cl. G06Q 30/02; H04N 21/478; H04N 21/454; H04N 21/2187

(52) U.S. Cl. CPC G06Q 30/0235; H04N 21/478; H04N 21/454; H04N 21/2187

(57) ABSTRACT

A system and method of sponsoring streaming funding is proposed. The system of sponsoring the streaming funding includes a streamer terminal configured to activate a funding function, generate streaming content, and transmit the streaming content to a streaming server; a sponsor terminal configured to transmit a funding amount for sponsoring a streamer to a sponsorship server; and the sponsorship server configured to display, on a streamer's broadcast screen, a sponsorship widget including at least one of a funding target amount, a target time period, and a funding sponsorship amount, when the funding function is activated by the streamer terminal, update the funding sponsorship amount on the sponsorship widget whenever a sponsorship event occurs, and provide the funding sponsorship amount to the streamer when the funding sponsorship amount reaches the funding target amount within the target time period.

### CROSS REFERENCE TO RELATED APPLICATION

This application is based on and claims priority from Korean Patent Applications Nos. 10-2022-0004651 filed on Jan. 12, 2022 and 10-2022-0025035 filed on Feb. 25, 2022 in the Korean Intellectual Property Office, the disclosure of which is incorporated herein in its entirety by reference.

### BACKGROUND OF THE INVENTION

### Field of the Invention

The present disclosure relates to a system and method of sponsoring streaming funding and, more particularly, to a system of sponsoring streaming funding, the system being able to sponsor a streamer according to conditions in a form of funding when the streamer is sponsored.

### Description of the Related Art

Unless otherwise indicated in the present disclosure, the content described in this section is not related art to the claims of this application and is not admitted to be the related art by inclusion in this section.

The number of streamers who conduct personal broadcasts using domestic and foreign streaming platforms such as YouTube, Afreeca, and Twitch, and the number of viewers watching the personal broadcasts are increasing. As shown in FIG. 1, a conventional streaming platform provides a one-way service in which a subject who conducts a broadcast transmits broadcast screens in real time by using an input device such as a camera or a microphone, and viewers unilaterally receive and watch the broadcast screens.

Viewers may sponsor a streamer by setting a mission with the streamer who is streaming, and paying sponsorship money in return for success of the mission. When the viewers sponsor the streamer, an event screen informing sponsorship as a kind of reward concept for the sponsorship may be transmitted together. In this case, since each of sponsors proceeds with his or her sponsorship separately, there is a problem that sponsorship amount may be different every day, and the sponsorship amount equal to an amount desired by the streamer may not be raised. In addition, when the streamer fails to fulfill his or her promise or mission, there is a problem that it is difficult to refund the sponsorship amount.

### Documents of Related Art

### [Patent Documents]

(Patent Document 1) Korean Patent No. 10-2352031 (registered on Jan. 12, 2022)

(Patent Document 2) Korean Patent No. 10-2197203 (registered on Dec. 24, 2020)

### SUMMARY OF THE INVENTION

In an exemplary embodiment, there is provided a system of sponsoring streaming funding that enables a streamer to raise a sponsorship amount as much as he or she desires. In addition, in the exemplary embodiment, when the streamer fails to fulfill his or her mission or promise, the funded sponsorship amount is refunded to each sponsor. In addition, when a funding amount raised during a predetermined time period does not reach a target amount, the funding amount is refunded to each sponsor.

In addition, the present disclosure should not be limited to the technical challenges described herein, but it is apparent that other technical challenges could also be derived from the description disclosed herein.

A system of sponsoring streaming funding according to the exemplary embodiment includes: a streamer terminal configured to activate a funding function, generate streaming content, and transmit the streaming content to a streaming server; a sponsor terminal configured to transmit a funding amount for sponsoring a streamer to a sponsorship server; and the sponsorship server configured to display, on a streamer's broadcast screen, a sponsorship widget including at least one of a funding target amount, a target time period, and a funding sponsorship amount, when the funding function is activated by the streamer terminal, update the funding sponsorship amount on the sponsorship widget whenever a sponsorship event occurs, and provide the funding sponsorship amount to the streamer when the funding sponsorship amount reaches the funding target amount within the target time period.

The sponsorship server according to the exemplary embodiment may include: a widget registration module configured to generate the sponsorship widget including at least one of the funding target amount, the target time period, and the funding sponsorship amount, and expose the sponsorship widget on the streamer's broadcast screen when the funding function activates the generated sponsorship widget; a settlement module configured to determine whether a target sponsorship amount is raised or not within a time period set by the streamer; and a mission performance confirmation module configured to determine whether a mission proposed by the streamer is fulfilled, through at least one of image detection, manager confirmation, and sponsor confirmation.

The settlement module according to the exemplary embodiment may refund the funding amount to each sponsor when a sponsorship amount raised within the time period set by the streamer does not reach the target sponsorship amount.

The settlement module according to the exemplary embodiment may determine whether to allow the streamer to receive the funding amount or not according to a mission performance result when the sponsorship amount raised within the time period set by the streamer reaches the target sponsorship amount.

The settlement module according to the exemplary embodiment may transmit the funding amount to the streamer when the sponsorship amount raised within the time period set by the streamer reaches the target sponsorship amount and the mission is completed.

The system and method of sponsoring the streaming funding as described above may raise the sponsorship amount as much as the amount desired by the streamer through a funding function provided by a streaming system, whereby profits of the streamer may be improved. In addition, each sponsor may also watch a process in which the target amount is raised, whereby the interest or fun of each sponsor may be improved.

In addition, when a mission fails, a penalty may be imposed and the sponsorship amount may be refunded to each sponsor, thereby contributing to the profit generation of each sponsor and a streaming platform.

In addition, when the sponsorship amount raised within the predetermined time period does not reach the target amount or the streamer fails to fulfill his or her promise or mission, the raised sponsorship amount is refunded to each sponsor, whereby unnecessary sponsorship amount expenditure of each sponsor may be reduced.

The effects of the present disclosure are not limited to the above effects, and should be understood to include all effects that can be inferred from the detailed description of the present disclosure or the configuration of the present disclosure described in the claims.

### BRIEF DESCRIPTION OF THE DRAWINGS

FIG. 1 is a view illustrating a conventional streaming platform.

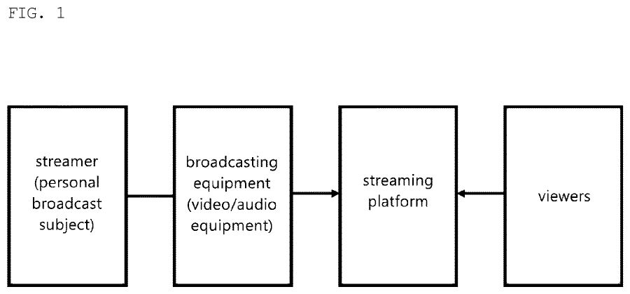

FIG. 2 is a view illustrating a configuration of a system of sponsoring streaming funding according to an exemplary embodiment.

FIG. 3 is a view illustrating a configuration for data processing of a sponsorship server according to the exemplary embodiment.

FIG. 4 is a view illustrating a data processing flow of the sponsorship server for sponsoring the streaming funding according to the exemplary embodiment.

### DETAILED DESCRIPTION OF THE INVENTION

Advantages and features of the present disclosure and the methods of achieving the same will become apparent with reference to exemplary embodiments described below in detail in conjunction with the accompanying drawings. However, the present disclosure is not limited to the exemplary embodiments disclosed below, but will be implemented in a variety of different forms. These exemplary embodiments are provided only to complete the disclosure of the present disclosure and to completely inform the scope of the present disclosure to those skilled in the art to which the present disclosure pertains, and the present disclosure is only defined by the scope of the claims. Like reference numerals generally denote like elements throughout the present disclosure.

In the following descriptions of the exemplary embodiments of the present disclosure, it is to be noted that, when a detailed description of a known function or configuration may unnecessarily obscure the subject matter of the present disclosure, the detailed description thereof will be omitted. In addition, terms to be described later are terms defined in consideration of functions in the exemplary embodiments of the present disclosure, which may vary according to the intention or custom of users or operators. Therefore, definitions of these terms should be made on the basis of the content throughout the present specification.

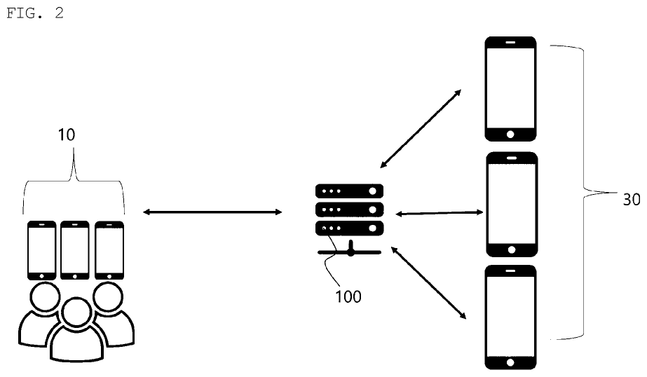

FIG. 2 is a view illustrating a configuration of a system of sponsoring streaming funding according to the exemplary embodiment.

Referring to FIG. 2, the system of sponsoring the streaming funding according to the exemplary embodiment may be configured to include a streamer terminal 10, a sponsor terminal 30, and a sponsorship server 100. The streamer terminal 10 activates a funding function, generates streaming content, and transmits the streaming content to a streaming server. The sponsor terminal 30 transmits a funding amount to be sponsored to a streamer by transmitting via the sponsor server 100.

When the funding function is activated by the streamer terminal, the sponsor server 100 generates a sponsorship widget including at least one of a funding target amount, a target time period, and a funding sponsorship amount, and outputs the sponsorship widget to a streamer's broadcast screen. In the exemplary embodiment, the sponsorship server 100 updates the funding sponsorship amount of the sponsorship widget whenever a sponsorship event occurs. After that, when the funding sponsorship amount reaches the funding target amount within the target time period, the funding sponsorship amount is provided to the streamer according to whether the streamer's mission or promise is fulfilled or not.

Here, at least one terminal may be implemented as a computer capable of connecting to a remote server or remote terminals through a network. Here, the computer may include, for example, a navigation device, a notebook computer, a desktop, a laptop, and the like, which are equipped with respective web browsers. Here, at least one purchaser terminal may be implemented as a terminal capable of connecting to the remote server or the remote terminals through the network. The at least one purchaser terminal, for example, may include, as wireless communication devices having guaranteed portability and mobility, a handheld-based wireless communication device of any kind, such as a navigation device, Personal Communication System (PCS), Global System for Mobile communications (GSM), Personal Digital Cellular (PDC), Personal Handyphone System (PHS), Personal Digital Assistant (PDA), International Mobile Telecommunication (IMT)-2000, Code Division Multiple Access (CDMA)-2000, W-Code Division Multiple Access (W-CDMA), WiBro (Wireless Broadband Internet) terminal, a smartphone, a smartpad, a tablet PC, etc.

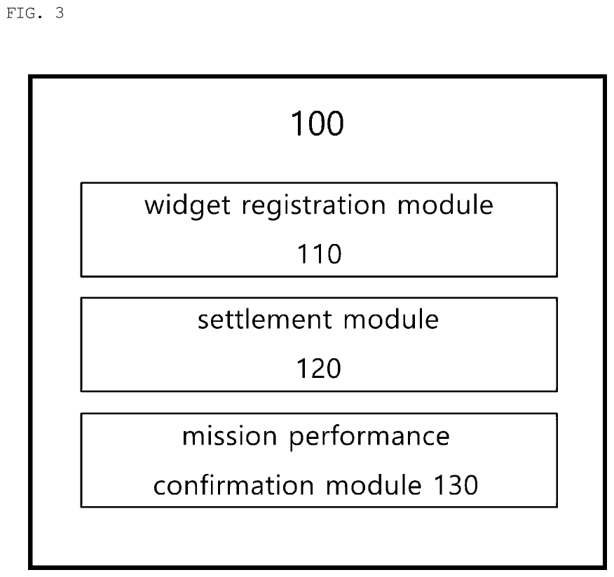

FIG. 3 is a view illustrating a configuration for data processing of the sponsorship server according to the exemplary embodiment.

Referring to FIG. 3, the sponsorship server 100 according to the exemplary embodiment may be configured to include a widget registration module 110, a settlement module 120, and a mission performance confirmation module 130. The term “module” used in this specification should be interpreted as being able to include software, hardware, or a combination thereof, depending on the context in which the term is used. For example, the software may be a machine language, a firmware, an embedded code, and an application software. As another example, the hardware may be a circuit, a processor, a computer, an integrated circuit, an integrated circuit core, a sensor, a Micro-Electro-Mechanical System (MEMS), a passive device, or a combination thereof.

The widget registration module 110 generates a sponsorship widget including at least one of a funding target amount, a target time period, and a funding sponsorship amount, and outputs the generated sponsorship widget to a streamer's broadcast screen when a funding function is activated. In the exemplary embodiment, the widget registration module 110 updates the accumulated sponsorship amount whenever a sponsorship event by each sponsor occurs, so as to output the accumulated sponsorship amount to the sponsorship widget.

The settlement module 120 determines whether the target sponsorship amount is raised or not within a time period set by a streamer. In the exemplary embodiment, the settlement module 120 refunds the funding amount to each sponsor when the sponsorship amount raised within the time period set by the streamer does not reach the target sponsorship amount. In addition, in the exemplary embodiment, the settlement module 120 determines whether to allow the streamer to receive the funding amount or not according to a result of mission performance when the sponsorship amount raised within the time period set by the streamer reaches the target sponsorship amount.

The mission performance confirmation module 130 determines whether the mission proposed by the streamer is fulfilled or not through at least one of image detection, manager confirmation, and sponsor confirmation. The mission performance confirmation module 130 may select a mission performance confirmation method including the image detection, manager confirmation, and sponsor confirmation according to a type of the mission or promise that the streamer needs to fulfill in order to receive the sponsorship amount. In addition, the mission performance confirmation module 130 may confirm whether the mission is fulfilled or not according to completion level evaluation by each sponsor and a vote for or against on the performance completion by each sponsor after the streamer fulfills the mission or promise.

In the exemplary embodiment, the settlement module 120 transmits the funding amount to the streamer when the sponsorship amount raised within the time period set by the streamer reaches the target sponsorship amount and the mission is completed. In the exemplary embodiment, the settlement module 120 may calculate the sponsorship amount received by the streamer according to an evaluation result when each sponsor proceeds with the completion level evaluation on the mission or promise. For example, when the completion level evaluation is performed by means of scores, the settlement module 120 may allow the streamer to receive the sponsorship amount at a rate corresponding to an average score of the results of the completion level evaluation. The sum of the sponsorship amount received by the streamer according to the exemplary embodiment may be calculated according to Equation 1.

Sum of sponsorship amount received=(sum of sponsorship amount raised during predetermined time period)*(average score of evaluation/100) Equation 1

In the exemplary embodiment, the balance of the sponsorship amount after delivery of the sponsorship amount may be set as a commission or redistributed to each sponsor. In addition, in the exemplary embodiment, when the streamer fails to fulfill the promise or mission set in advance, the streamer may pay a predetermined ratio of the amount sponsored by each sponsor as a penalty, and the funding amount to which an amount equal to the penalty is added may be refunded to each sponsor. In the exemplary embodiment, the target funding amount within the time period is accumulated, but when the streamer fails to fulfill the mission, the predetermined ratio of the target funding amount is paid as the penalty, and the funding amount to which the amount equal to the penalty is added may be refunded to each sponsor. In the exemplary embodiment, the amount refunded to each sponsor when the mission fails may be calculated through Equation 2.

Sponsorship amount refunded after mission failure initial sponsorship amount+penalty/n Equation 2

(n: the number of sponsors)

In addition, in the exemplary embodiment, when the streamer fails to fulfill the mission, the predetermined ratio of the target funding amount is paid as the penalty, and the corresponding penalty may be refunded to each sponsor by proportionally distributing the penalty according to the initial sponsorship amount of each sponsor. That is, in the exemplary embodiment, a refund penalty proportional to the initial sponsorship amount is calculated so that each sponsor who paid a large amount of money is allowed to receive a large amount of the refund penalty. In the exemplary embodiment, the sponsorship amount refunded after the mission failure may be calculated through Equation 3.

Sponsorship amount refunded after mission failure=initial sponsorship amount+penalty*sponsorship amount/n*total sponsorship amount*100 Equation 3

(n: the number of sponsors)

Hereinafter, a method of sponsoring streaming funding will be described in sequence. Since operations (i.e., functions) of the method of sponsoring the streaming funding according to the exemplary embodiment are essentially the same as functions of the system of sponsoring the streaming funding, the description overlapping with FIGS. 2 and 3 will be omitted.

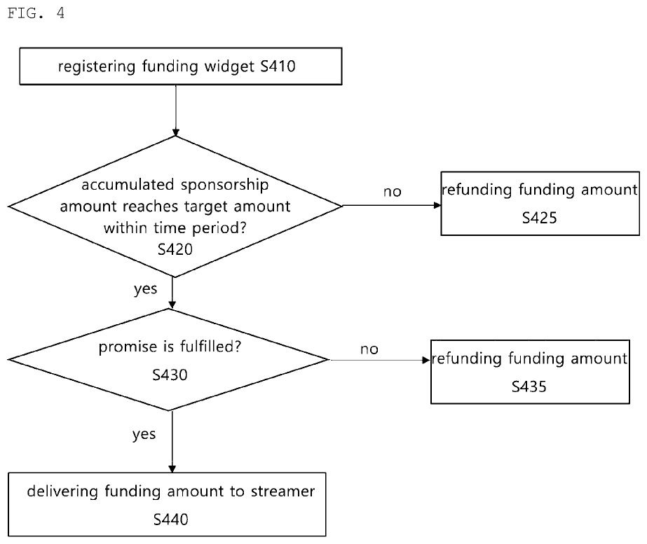

FIG. 4 is a view illustrating a data processing flow of a sponsorship server for sponsoring streaming funding according to the exemplary embodiment.

Referring to FIG. 4, in step S410, a widget registration module generates and registers a funding widget. In step S420, a settlement module confirms whether accumulated sponsorship amount within a time period reaches a target sponsorship amount or not. When the accumulated sponsorship amount reaches the target amount, an on-going process enters into step S430, and a mission performance confirmation module confirms whether a promise is fulfilled or not. When a streamer fulfills the promise, the on-going process enters into step S440 and delivers the funding amount to the streamer. When the accumulated sponsorship amount within the time period does not reach the target amount in step S420, the on-going process enters into step S425 and refunds the funding amount. When it is confirmed that the promise has not been fulfilled in step S430, the on-going process enters into step S435, and a settlement module refunds the funding amount to each sponsor.

In step S430, the settlement module may calculate the sponsorship amount received by the streamer according to an evaluation result when each sponsor proceeds with completion level evaluation on a mission or promise. For example, when the completion level evaluation is performed by means of scores, the settlement module may allow the streamer to receive the sponsorship amount at a rate corresponding to an average score of the results of the completion level evaluation.

In addition, in the exemplary embodiment, a balance of the sponsorship amount after delivery of the sponsorship amount may be set as a commission or redistributed to each sponsor. In addition, in the exemplary embodiment, when the streamer fails to fulfill the promise or mission set in advance, the streamer may pay a predetermined ratio of the accumulated sponsorship amount sponsored by each sponsor as a penalty, and the funding amount to which an amount equal to the penalty is added may be refunded to each sponsor. In addition, in the exemplary embodiment, a target funding amount within the time period is accumulated, but when the streamer fails to fulfill the mission, the predetermined ratio of the target funding amount is paid as the penalty, and the funding amount to which the amount equal to the penalty is added may be refunded to each sponsor.

In addition, in the exemplary embodiment, when the streamer fails to fulfill the mission, the predetermined ratio of the target funding amount is paid as the penalty, and the corresponding penalty may be refunded to each sponsor by proportionally distributing the penalty according to the initial sponsorship amount of each sponsor. That is, in the exemplary embodiment, the penalty corresponding to the paid sponsorship amount may be refunded by calculating the refund penalty proportional to the initial sponsorship amount. The system and method of sponsoring the streaming funding as described above may raise the sponsorship amount as much as the amount desired by the streamer through the funding function provided by the streaming system, thereby improving the profits of the streamer. In addition, each sponsor may also watch the process in which the target amount is raised, whereby the interest or fun of the sponsor may be improved.

In addition, when the mission fails, the penalty may be imposed and the penalty amount may be returned to each sponsor, thereby contributing to the profit generation of each sponsor and the streaming platform. In addition, when the sponsorship amount raised within the predetermined time period does not reach the target amount or the streamer fails to fulfill the promise or mission, the raised sponsorship amount is refunded to each sponsor, thereby reducing the unnecessary sponsorship amount expenditure of each sponsor.

The disclosed subject matter is only an example, and without departing from the gist of the claims claimed in the claims, various modifications may be made by those skilled in the art, so the scope of protection of the disclosed subject matter is not limited to the specific exemplary embodiment described above in detail.

What is claimed is:

1. A system of sponsoring streaming funding, the system comprising:
a streamer terminal configured to activate a funding function, generate streaming content, and transmit the streaming content to a streaming server;
a sponsor terminal configured to transmit a funding amount for sponsoring a streamer to a sponsorship server; and
the sponsorship server configured to display, on a streamer's broadcast screen, a sponsorship widget including at least one of a funding target amount, a target time period, and a funding sponsorship amount, when the funding function is activated by the streamer terminal, update the funding sponsorship amount on the sponsorship widget whenever a sponsorship event occurs, and provide the funding sponsorship amount to the streamer when the funding sponsorship amount reaches the funding target amount within the target time period.

2. The system of claim 1, wherein the sponsorship server comprises:
a widget registration module configured to generate the sponsorship widget including at least one of the funding target amount, the target time period, and the funding sponsorship amount, and expose the sponsorship widget on the streamer's broadcast screen when the funding function activates the generated sponsorship widget;
a settlement module configured to determine whether a target sponsorship amount is raised or not within a time period set by the streamer; and
a mission performance confirmation module configured to determine whether a mission proposed by the streamer is fulfilled, through at least one of image detection, manager confirmation, and sponsor confirmation.

3. The system of claim 2, wherein the settlement module refunds the funding amount to each sponsor when a sponsorship amount raised within the time period set by the streamer does not reach the target sponsorship amount.

4. The system of claim 3, wherein the settlement module determines whether to allow the streamer to receive the funding amount or not according to a mission performance result when the sponsorship amount raised within the time period set by the streamer reaches the target sponsorship amount.

5. The system of claim 4, wherein the settlement module transmits the funding amount to the streamer when the sponsorship amount raised within the time period set by the streamer reaches the target sponsorship amount and the mission is completed.

6. A method of sponsoring streaming funding, the method comprising:
(A) activating a funding function, generating streaming content, and transmitting the streaming content to a streaming server, by a streamer terminal;
(B) transmitting a funding amount for sponsoring a streamer to a sponsorship server, by a sponsor terminal; and
(C) displaying, on a streamer's broadcast screen, a sponsorship widget including at least one of a funding target amount, a target time period, and a funding sponsorship amount when the funding function is activated by the streamer terminal, updating the funding sponsorship amount on the sponsorship widget whenever a sponsorship event occurs, and providing the funding sponsorship amount to the streamer when the funding sponsorship amount reaches the funding target amount within the target time period, by the sponsorship server.

7. The method of claim 6, wherein step (C) comprises:
(C-1) generating the sponsorship widget including at least one of the funding target amount, the target time period, and the funding sponsorship amount, and exposing the sponsorship widget on the streamer's broadcast screen when the funding function activates the generated sponsorship widget, by a widget registration module;
(C-2) determining whether a target sponsorship amount is raised within a time period set by the streamer, by a settlement module; and
(C-3) determining whether the mission proposed by the streamer is fulfilled, through at least one of image detection, manager confirmation, and sponsor confirmation, by a mission performance confirmation module.

8. The method of claim 7, wherein, in step (C-2), the funding amount is refunded to each sponsor when the sponsorship amount raised within the time period set by the streamer does not reach the target sponsorship amount.

9. The method of claim 8, wherein, in step (C-2), whether to allow the streamer to receive the funding amount or not is determined according to a mission performance result when the sponsorship amount raised within the time period set by the streamer reaches the target sponsorship amount.

10. The method of claim 9, wherein, in step (C-2), the funding amount is transmitted to the streamer when the sponsorship amount raised within the time period set by the streamer reaches the target sponsorship amount and the mission is completed.
